(19) United States
(12) Patent Application Publication
(10) Pub. No.: US 2017/0321653 A1
(43) Pub. Date: Nov. 9, 2017

(54) Floating Wind Turbine Structure with Reduced Tower Height and Method for Optimising the Weight Thereof

(71) Applicant: Envsion Energy (Denmark) ApS, Silkeborg (DK)

(72) Inventors: Anders Varming Rebsdorf, Skanderborg (DK); Michael Friedrich, Silkeborg (DK)

(21) Appl. No.: 15/535,188

(22) PCT Filed: Oct. 27, 2015
(86) PCT No.: PCT/DK2015/050326

§ 371 Date: Jun. 12, 2017

(30) Foreign Application Priority Data
Dec. 12, 2014 (DK) PA 2014 70776

(51) Int. Cl. F03D 7/02; B63B 35/44; F03D 13/25; B63B 39/00; F03D 17/00; F03D 1/06

(52) U.S. Cl. CPC F03D 7/0268; F03D 17/00; B63B 35/44; F03D 1/06; F03D 13/25; B63B 39/005; F05B 2240/912; F05B 2240/93; B63B 2035/446

(57) ABSTRACT

The present invention relates to a method and a wind turbine structure for optimising the weight of the wind turbine and the offshore foundation. The wind turbine is operated based on the measured wave height which in turn allows the tower height to be reduced so that the ratio between the tower height and the length of the wind turbine blades is greater than 0.5. The rotor is parked in a predetermined position with a maximum or minimum clearance between the tip end of the wind turbine blades and the sea level if the measured wave height exceeds a predetermined threshold. A monitoring unit arranged relative to the wind turbine detects if one or more objects are located within a monitoring area. If an object is located within the monitoring area, the wind turbine is shut down and the rotor is rotated to the parked position.

### FIELD OF THE INVENTION

The present invention relates to a method for optimising the weight of a wind turbine structure which comprises a wind turbine provided on an offshore foundation.

The present invention also relates to a wind turbine structure comprising a wind turbine configured to be installed on an offshore foundation in an offshore location.

### BACKGROUND OF THE INVENTION

It is known that the floating foundations for wind turbines are large and heavy structures designed to provide sufficient stability and buoyancy to the wind turbine during operation and in extreme conditions. It is further known that the wind turbine tower acts as a large moment arm during tilting movement of the wind turbine, thus the floating foundation also has to counteract the bending moment introduced into the floating foundation during tilt. Traditionally, this is solved by increasing the size and weight of the floating foundation which increases the production costs and optionally also the installation costs.

Furthermore, additional structural strength is needed at the top of the wind turbine tower for compensating this bending moment and the structural loads introduced into the wind turbine tower via the wind loads as well as the wave and current loads. This is traditionally solved by adding extra material to the top end of the wind turbine tower, thus increasing the weight of the wind turbine tower, and hereby increasing the production costs.

The wind turbine should have a tower height that is between two to three times the length of the wind turbine blades, this provides an optimal balance between the costs of the wind turbine tower and the increased power output capacity at higher attitudes.

US 2014/0219797 A1, a patent application from the present applicant, discloses a partial-pitch wind turbine placed on a floating foundation which in turn is moored to the seabed. The wind turbine comprises two wind turbine blades each having an inner blade section connected to a pitchable outer blade section which is pitched to substantially maintain a constant resultant thrust value acting on the rotor hub. The size and weight of the floating foundation may thus be reduced due to this pitching scheme.

EP 2080899 A1 discloses a two-bladed wind turbine placed on a floating spar buoy shaped foundation which is anchored to the seabed via anchoring cables connected at the bottom end. In this configuration, the drive train is arranged in the floating foundation, and a flexible and bendable tower part and rotor shaft part are located between the rotor and the drive train. Stresses and loads of the wind turbine are concentrated at these flexible parts, thus they are likely to fail. Furthermore, the wind turbine tower will still be subject to large bending moment due to the large tilting range of the rotor and the wind turbine tower relative to the floating foundation.

U.S. Pat. No. 8,192,160 B2 also discloses a wind turbine placed on a floating spar buoy shaped foundation which is anchored to the seabed via anchoring cables connected to the side of the floating foundation. The height of the nacelle relative to nominal sea level can be adjusted in normal operation by pumping water in or out of a ballast tank arranged inside the floating foundation and adjusting the length of the anchoring cables at the same time. The amount of ballast is regulated based on the wind speed. The adjusting mechanism and sealing means thereof add to the complexity and the production costs of the floating foundation. The tensioning of the anchoring cables introduces accelerated wear between the individual anchor links, thus reducing the operation time of the anchoring system.

US 2010/0119370 A1 discloses a wind turbine wherein the control system of the wind turbine controls the pitch mechanism and is connected to a wave height sensor. The control system is configured to determine the wave height based on the measured data from this wave height sensor. The control system sends a control signal to the pitch mechanism which then pitches wind turbine blades out of the wind and thus causing the rotor to stall when high waves are detected. The document is silent about the type of foundation or the height of the wind turbine.

### OBJECT OF THE INVENTION

An object of this invention is to provide a solution that solves the above-mentioned problem of the prior art.

An object of this invention is to provide a method for optimising the weight of the wind turbine tower and of the offshore foundation.

An object of this invention is to provide an alternative method for operating a wind turbine that allows the height of the wind turbine to be reduced.

An object of this invention is to provide an alternative wind turbine structure that allows the weight of the wind turbine tower and of the offshore foundation to be optimised while reducing the bending moments.

### DESCRIPTION OF THE INVENTION

An object of the invention is achieved by a method for optimising the weight of a wind turbine structure, the wind turbine structure comprises a wind turbine provided on an offshore foundation, the wind turbine comprises a rotor with at least two wind turbine blades and a rotor hub, the wind turbine further comprises wind turbine tower, where the method comprises the steps of:
providing the wind turbine with a distance between a sea level and a lowermost position of a tip end of the wind turbine blades which is equal to or less than 20 metres,
measuring at least a wave height,
operating the wind turbine according to the measured wave height,
positioning the rotor in a parked position with a maximum clearance between the wind turbine blades and the sea level if at least the measured wave height exceeds a predetermined threshold.

This provides a simple and easy method for optimising the weight of the wind turbine as well as the weight of the offshore foundation by reducing the clearance between the lowermost position of the tip end of the wind turbine blades and a mean sea level or nominal sea level. The sea level may alternatively be defined as the mean sea level at high tide or the mean sea level at low tide. In example, the sea level may be defined as the sea level at highest astronomical tide (HAT) or the sea level at mean high water springs (MHWS). No need for ballast systems to raise and lower the wind turbine relative to the sea level as function of the wind speed or in event of an extreme wind condition. This method is well-suited for wind turbines having two or three wind turbine blades.

This configuration provides an alternative method for operating a wind turbine that allows the tower height to be reduced which in turn also reduces the moment arm of the wind turbine structure. This allows the bending moment introduced into the wind turbine to be significantly reduced, thus saving material and costs of the wind turbine tower. This configuration also allows the size and weight of the offshore foundation to be reduced, as the forces and bending moment introduced into the offshore foundation via the wind turbine are reduced, thereby further reducing the costs of the offshore foundation.

The rotor, e.g. the wind turbine blades, is parked in one or more predetermined positions depending on the measured values from various sensors or measuring units and/or reasons for operating the wind turbine, such as high waves, extreme wind conditions, service works, an emergency situation, or in a safety situation as described later. The rotor may be parked in a position so that at least one of the wind turbine blades extends in a parallel or perpendicular direction relative to the wind turbine tower. Preferably, the rotor is parked in a position that provides the maximum distance between the wind turbine blades and the sea level.

According to one embodiment, the predetermined threshold is 18 metres or less, preferably between 5 metres and 15 metres.

The wind turbine, e.g. the control unit thereof, monitors the measured wave height and activates the parking procedure if the measured wave height exceeds at least one predetermined threshold value. The threshold value may be 18 metres or less, preferably between 5 metres and 15 metres, e.g. 10 metres or 12 metres. The wave height may be measured as the distance from the wave crest to the wave through, or as the amplitude from the mean sea level to the wave crest. The amplitude is then used to calculate the wave height. Alternatively, the wave height may be determined as the significant wave height (SWH) over a predetermined time period.

According to one embodiment, the method further comprises determining a ratio between a blade length of one of the at least two wind turbine blades and a tower height of the wind turbine tower, wherein the ratio of the wind turbine is greater than 0.5.

This configuration enables the ratio between the longitudinal length, e.g. the blade length, of each wind turbine blade and the longitudinal length, e.g. the tower height, of the wind turbine tower to be increased compared to conventional wind turbines. In a conventional wind turbine, the wind turbine is designed so that it has a tower height that is at least two times the blade length. This means for a conventional wind turbine that the ratio between the blade length and the tower height is less than 0.5 whereas the present configuration enables the wind turbine to have a reduced tower height while maintaining the length of the wind turbine blades. This reduces the tilting velocity and acceleration of the nacelle as the moment arm is reduced. This also saves material and weight of the top end of the wind turbine tower as less material is needed to achieve the required stiffness, thus saving costs.

The tower height may be selected so that the wind turbine structure has a clearance between a lowermost position of the tip end of the wind turbine blades during rotation and the sea level which is equal to or less than 20 metres, preferably between 10 metres and 18 metres, e.g. 12 metres or 15 metres.

According to one embodiment, the wind turbine is operated in a normal operation mode if the measured wave height is equal to or below the threshold.

The wind turbine and thus the rotor are operated in a normal operation mode when low waves are detected, e.g. the measured wave height does not exceed the threshold. The wind turbine is operated in the normal operation mode when the measured wind speed is equal to or greater than a rated or nominal wind speed and less than a cut-out wind speed. In this normal operation mode, the wind turbine blades are pitched according to a predetermined power output profile, e.g. to maintain a nominal power output. Optionally, the speed of the rotor may also be regulated according to the predetermined power output profile. The control unit, e.g. the wind turbine control unit, controls the operation of the wind turbine and thus the rotor based on the measured wind speed and the measured wave height, thus enabling the wind turbine to continue to produce power as long as the waves remain within an acceptable range.

In a further embodiment, the wind turbine is operated in a normal start-up mode if the measured wave height is equal to or below the threshold. The wind turbine is operated in the normal start-up mode when the measured wind speed is below the rated or nominal wind speed and optionally equal to or greater than a predetermined cut-in wind speed. In this operation mode, the wind turbine blades are pitched to a pitch angle of zero according to the predetermined power profile, e.g. to produce a maximum power output. This allows the wind turbine to continue to produce power as mentioned above.

According to one embodiment, the wind turbine is operated in a shutdown mode if the measured wave height is above the threshold.

If high waves are detected, e.g. the measured wave height exceeds the threshold, then the wind turbine and thus the rotor are switched out of the normal operation or start-up mode and into a shutdown mode. In the shutdown mode, the control unit shuts down the wind turbine, e.g. the drive train thereof, so that it does produce a power out. Optionally, the power convertor unit is switched off the external grid network. The wind turbine blades are pitched to a feathered position or a position in which the loads on the wind turbine blades are reduced to a minimum. The wind turbine may also be switched into the shutdown mode by the control unit for other reasons, such as extreme wind conditions, service works, a safety situation as described later, or if a failure or emergency situation is detected.

In the shutdown mode, the rotor is rotated into a parked position and optionally locked in this position, e.g. by means of a rotor locking system. A braking system, e.g. a hydraulic or mechanical brake mechanism, may be used to brake/stop the rotation of the rotor. Alternatively or additionally, the pitching of the wind turbine blades and/or the generator operated in an inversed mode may be used to brake the rotor and rotate it into the parked position. The rotor and thus the wind turbine blades may be parked in one or more predetermined positions depending on the measured wind speed and/or wave height or other reasons, such as service works.

If the wind turbine is a two-bladed wind turbine, then the wind turbine blades may be parked in a horizontal position or in a vertical position. In the vertical position, the wind turbine blades extend in a parallel direction relative to the wind turbine tower where one of the wind turbine blades extends downwards along the wind turbine tower. In the horizontal position, the wind turbine blades extend in a perpendicular direction relative to the wind turbine tower. This reduces the risk of waves hitting the wind turbine blades in an extreme condition, e.g. large waves exceeding the threshold or wind speed exceeding the cut-out wind speed. If the wind turbine is a three-bladed wind turbine, then one of the wind turbine blades may be parked in a vertical position parallel to the wind turbine tower. In the vertical position, the one wind turbine blade extends either downwards along the wind turbine tower or upwards away from the wind turbine tower. If the one wind turbine is facing upward and away from the wind turbine tower, then the risk of waves hitting the wind turbine blades during extreme conditions is reduced.

According to a specific embodiment, the method further comprises monitoring a predetermined area relative to the offshore foundation, wherein the wind turbine is further operated in the shutdown mode if at least one moving object is detected with this area.

In the event of a safety situation, the wind turbine is operated in the shutdown mode where the rotor is parked in a predetermined position, e.g. the horizontal or vertical position as mentioned above. A monitoring system connected to the control unit detects any vessels, persons in need of rescue or even helicopters within a predetermined distance from the wind turbine structure. If an object is detected within this distance, then the control unit shut downs the wind turbine as mentioned above. The monitoring system defines a safety zone around the wind turbine, thus reducing the risk of the wind turbine blades hitting a vessel, a person in distress or a helicopter located within the safety zone.

The monitoring system may optionally determine the direction and speed of the vessel, the person in distress or the helicopter, thus allowing the wind turbine only be shut down if it is determined that the object is approaching the wind turbine. The wind turbine may alternatively be shut down if the control unit or monitoring system receives a command signal transmitted from a remote station or a remote unit located on the vessel or helicopter. Optionally, the control unit may selectively park the wind turbine blades in the vertical or horizontal position dependent on the location of said object relative to the orientation, e.g. the yaw angle, of the rotor of the wind turbine and/or dependent on the type of object detected. Furthermore, the measured wave height and/or wind speed may also be used to determine the parked position of the wind turbine blades.

According to one embodiment, the step of positioning further comprises yawing the nacelle into a parked position in which the rotor is arranged on an opposite side of an outer ladder which provides access to the wind turbine.

The nacelle is in the shutdown mode yawed to a predetermined position and optionally locked in this position, e.g. by means of a yaw locking system. The nacelle may be actively yawed using a yaw system arranged in the wind turbine or passively yawed using the wind acting on the rotor. The nacelle and thus the rotor may be positioned on the opposite side of an outer ladder or another boat landing structure providing access to the wind turbine structure. The yawing may be done before, during or after the wind turbine blades are rotated into the parked position. This allows any service vessels to move into position relative to an outer platform of the wind turbine even if blades are parked in a vertical position.

An object of the invention is also achieved by a wind turbine structure comprising:
an offshore foundation configured to be installed at an installation site, the offshore foundation comprises an installation interface for a wind turbine,
a wind turbine tower configured to be installed on the offshore foundation, a nacelle provided on top of the wind turbine tower, and a rotor rotatably mounted to the nacelle, the rotor comprises at least two wind turbine blades mounted to a rotor hub, the wind turbine further comprises a control unit configured to control the operation of the wind turbine, wherein
at least one measuring unit is configured to measure a wave height, the measuring unit being configured to communicate with the control unit, characterised in that
the wind turbine is further configured to position the rotor in a parked position with a maximum clearance between the at least two wind turbine blades and a sea level if the measured wave height exceeds a predetermined threshold, wherein the distance between the sea level and the lowermost position of a tip end of the at least two wind turbine blades is equal to or less than 20 metres.

This provides a wind turbine structure that allows the weight of the wind turbine tower and of the offshore foundation to be optimised by operating the wind turbine according to the measured wave height. This configuration eliminates the need for a ballast system to raise and lower the wind turbine relative to the sea level as function of the wind speed. This allows the tower height and thus the moment arm of the wind turbine to be reduced compared to conventional offshore wind turbines. This in turn reduces the bending moment and forces introduced into the offshore foundation which means that a lighter and/or smaller structure are required to counteract these forces, thereby saving costs of the offshore foundation.

According to one embodiment, the offshore foundation is a floating foundation.

The offshore foundation may be any type of offshore foundation suitable for installing the wind turbine at an offshore location. The offshore foundation may be a mono-pole, a gravity foundation, a tripod foundation, a jacket foundation, a tri-pile foundation or a floating foundation. The floating foundation may be any type of floating structure comprising at least one, two, three or more buoyancy chambers.

According to one embodiment, the distance between the sea level and the lowermost position is between 10 metres and 18 metres.

The wind turbine has a reduced tower height compared to conventional offshore wind turbines. The wind turbine is configured so that it has a ratio between the blade length and the tower height of at least 0.5, preferably between 0.5 and 0.9. Conventional offshore wind turbines has a ratio of less than 0.5 since the wind turbine tower is designed to have a tower height of at least two times the length of the wind turbine blades. Furthermore, conventional offshore wind turbines are often designed so that extreme waves of about 18 metres are not able to hit the wind turbine blades. This allows the clearance between the lowermost position of the tip end of the wind turbine blade and the sea level to be reduced. This also reduces the tilting velocity and acceleration of the nacelle as the tower height is reduced, thus saving material and weight of the top end of the wind turbine tower which in turn reduces the costs.

The tower height may be selected so that the wind turbine structure has a clearance between a lowermost position of the tip end of the wind turbine blades during rotation and the sea level which is equal to or less than 20 metres, preferably between 10 metres and 18 metres, e.g. 12 metres or 15 metres.

According to one embodiment, the at least one measuring unit is arranged on the wind turbine structure or positioned relative to the offshore foundation.

The measuring unit is configured to be positioned relative to the offshore foundation or the wind turbine so that it is able to measure the wave height. The measuring unit may comprise a radar, a camera, an electromagnetic transmitter and receiver or other suitable measuring means for wirelessly measuring the wave height. The measuring unit may further comprise any suitable processing means, e.g. a microprocessor or another electronic circuit, for processing the data from the measuring means and determine the wave height or a signal representative of the wave height. Alternatively, the measuring unit may comprise a buoy or another buoyant element configured to be placed at the sea level or at a predetermined depth, such as a wave sensor, a sonar, a gyroscope, one or more accelerometers, a GPS unit or another suitable measuring unit. The measuring unit may instead be configured to be placed at the seabed, such as an upwards looking sonar. Two or more measuring units may be used to determine the wave height. The measuring unit(s) may be connected to the control unit via electrical cables or a wireless connection.

According to one embodiment, the wind turbine structure further comprises at least one monitoring unit configured to monitor a predetermined area relative to the offshore foundation, where the at least one monitoring unit is configured to detect at least one moving object within this area.

The monitoring unit is arranged on the wind turbine or on the offshore foundation and is configured to detect objects within a predetermined distance from the wind turbine structure. The monitoring unit defines a monitoring area around the wind turbine is configured to detect vessels, persons in distress, large block of ice or even helicopters located within this monitoring area. The monitoring unit may comprise a radar, a camera, a transmitter and a receiver, or other suitable monitoring means for detecting objects within the monitoring area. The monitoring unit further comprises any suitable means, e.g. a microprocessor or another electronic circuit, for processing the data and determining if an object is located within the monitoring area. The control unit is configured to communicate with the monitoring unit via a wired or wireless connection. This increases the safety around the wind turbine as the wind turbine is shut down if an object is located too close or is approaching the wind turbine, thus reducing the risk that the object is struck by the wind turbine blades.

Alternatively or additionally, the monitoring unit may comprise an optional GPS receiver and a communication module configured to communicate with one or more external units located on a vessel, a life jacket or a helicopter or one or more external central stations. The communications module may communicate with the external unit or station via very-high frequency (VHF) signals. The external station and/or unit may form part of a vessel monitoring system (VMS), an automatic identification system (AIS), a vessel traffic service (VTS), or another relevant system. This allows the monitoring unit to determine if the vessel, helicopter or person is located with the monitoring area based on at least the received position data. This also allows the monitoring unit or the control unit to send the position data of the wind turbine to any vessel or helicopter located within the monitoring area or even to an external system, such as a traffic monitoring system.

According to one embodiment, the wind turbine is configured to operate in a normal operation mode if no control signal is received from the monitoring unit, wherein said control signal either indicative of the at least one moving object being located within this area or indicative of the at least one moving object is not approaching the wind turbine.

The control unit of the wind turbine is configured to operate the wind turbine in the normal operation mode, as mentioned earlier, when no objects are detected with this safety zone and/or when said object is determined not to move towards the wind turbine. In this normal operation mode, the control unit may be configured to maximise the power output or maintain a nominal power output of the wind turbine. The control unit may be configured to switch between the normal operation mode and the shutdown mode based on one or more suitable control signals from the monitoring unit. Said control signals may indicate whether or not one or more moving objects are located within this safety zone and/or whether one or more of the detected objects are approaching the wind turbine or not.

According to one embodiment, the wind turbine is configured to operate in a normal operation mode if the measured wave height is below the threshold.

The control unit is, in this normal operation mode, configured to pitch the wind turbine blades according to a predetermined power output profile, as mentioned earlier. The pitching may be carried out via a local pitch control system connected to the control unit. This allows the wind turbine to continue to produce power if no high waves are detected. The wind turbine is switched to the shutdown mode if the measured wave height exceeds the threshold. In this configuration, the downtime may be greater than that of a conventional offshore wind turbine due to the maximum allowable wave height.

According to one embodiment, the wind turbine comprises three wind turbine blades.

The wind turbine in this configuration comprises at least two or three wind turbine blades. The rotor is preferably parked in a predetermined position with a maximum clearance between the tip end of a downwards facing wind turbine blade and the sea level. For a two-bladed wind turbine, this is achieved by rotating the wind turbine blades into a horizontal position. For a three-bladed wind turbine, this is achieved by rotating one of the wind turbine blades into a vertical direction so that it extends away from the wind turbine tower. This reduces the risk of the wind turbine blades hitting vessel or another object to a minimum. This also allows the rotor to passively or actively align itself with the wind direction and thereby track the wind direction as it shifts.

The rotor is optionally parked in a predetermined position with a minimum clearance between the tip end of a downwards facing wind turbine blade and the sea level. For a two-bladed wind turbine, this is achieved by rotating the wind turbine blades into a vertical position. For a three-bladed wind turbine, this is achieved by rotating one of the wind turbine blades into a vertical direction so that it extends downwards along the wind turbine tower. This reduces the total surface area which is influenced by the incoming wind, this position is suitable for extreme wind conditions or service works.

### DESCRIPTION OF THE DRAWING

The invention is described by example only and with reference to the drawings, wherein:

FIG. 1 shows a conventional wind turbine installed on an offshore foundation;

FIG. 2 shows an exemplary embodiment of the wind turbine structure according to the invention;

FIG. 3 shows an exemplary embodiment of a monitoring unit for detecting objects with a monitoring area;

FIG. 4 shows a first exemplary embodiment of a measuring unit for measuring the wave height; and

FIG. 5 shows a second exemplary embodiment of the measuring unit for measuring the wave height.

In the following text, the figures will be described one by one and the different parts and positions seen in the figures will be numbered with the same numbers in the different figures. Not all parts and positions indicated in a specific figure will necessarily be discussed together with that figure.

### REFERENCE LIST

1 Wind turbine
2 Offshore foundation
3 Wind turbine blades
4 Inner blade section
5 Outer blade section
6 Pitch junction
7 Rotor hub
8 Nacelle
9 Wind turbine tower
10 Sea level
11 Wind turbine
12 Offshore foundation
13 Wind turbine tower
14 Seabed
15 Anchoring lines, chains
16 Monitoring unit
17 Object, vessel
18 Measuring unit, buoy
19 Buoyant element
20 Anchoring lines
21 Measuring unit, sonar

### DETAILED DESCRIPTION OF THE INVENTION

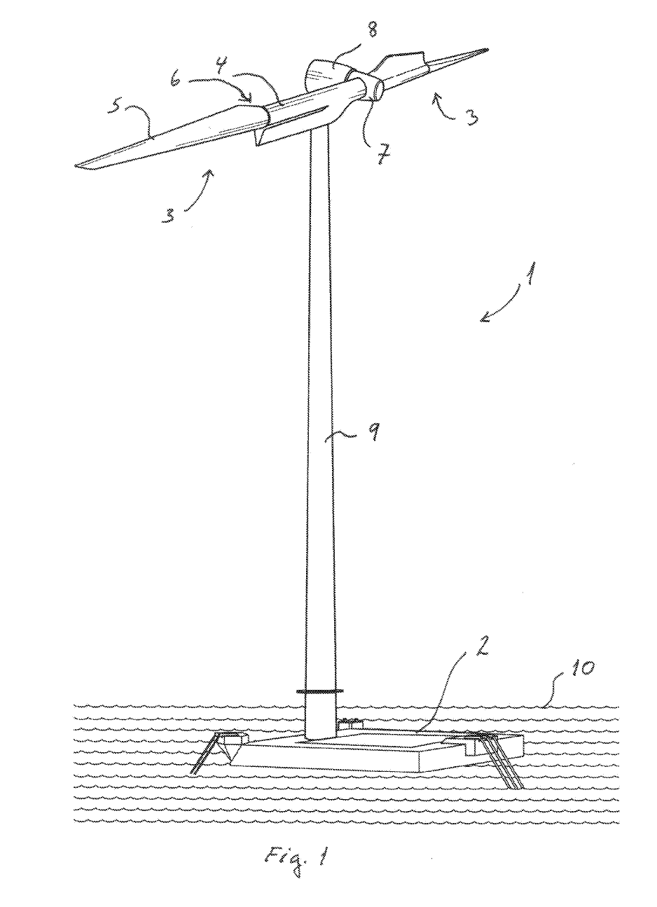

FIG. 1 shows a conventional wind turbine 1 arranged on an offshore foundation 2. The wind turbine 1 is here shown as a two-blade wind turbine, but it may comprise three wind turbine blades. The wind turbine blades 3 are here shown as partial-pitch blades, but the wind turbine blades 3 may be full-span blades. The wind turbine blade 3 comprises an inner blade section 4 connected to an outer blade section 5 via a pitch junction 6. The wind turbine blades 3 are mounted to a rotor hub 7 which is rotatably mounted to a nacelle 8. The nacelle 8 is arranged on top of a wind turbine tower 9 having a predetermined tower height.

In this embodiment, the wind turbine 1 has a ratio between a blade length of the wind turbine blades 3 and the tower height of the wind turbine tower 9 of less than 0.5. The nacelle 8 and rotor hub 7 are placed at a predetermined hub height relative to a sea level 10 so that a sufficient clearance between the lowermost position of the tip end of the wind turbine blades 3 and the sea level 10 is achieved.

The offshore foundation 2 is here shown as a floating foundation, but may be a different type of offshore foundation, such as a mono-pole, a tripod, a jacket foundation, or a gravity foundation.

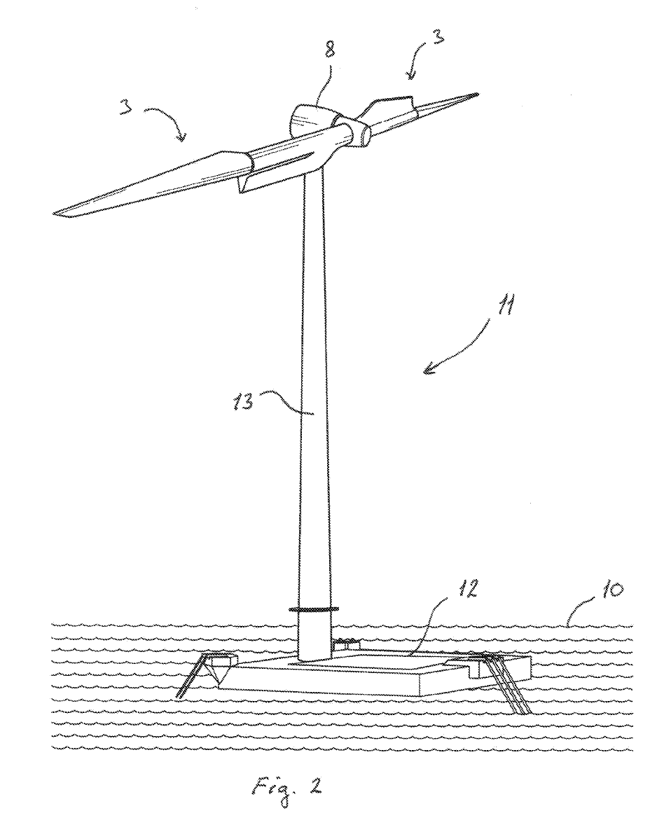

FIG. 2 shows an exemplary embodiment of a wind turbine 11 and an offshore foundation 12 according to the invention. In this embodiment, the wind turbine 11 has a reduced tower height compared to the wind turbine 1.

The wind turbine 11 comprises a wind turbine tower 13 which has a tower height of less than two times than the blade length of the wind turbine blades 3, thus the ratio is greater than 0.5, preferably between 0.5 and 0.9. The wind turbine blade 3 in this embodiment has the same blade length as the wind turbine blades 3 shown in FIG. 1. This reduces the moment arm and thus the bending moment of the wind turbine 11 which in turn reduces the tilting velocity and acceleration of the nacelle 8. This also saves material and costs of the wind turbine tower 13. The reduced tower height also means that the wind turbine tower 13 has a higher resonance frequency, thus making it less prone to resonate.

The offshore foundation 12 is here shown as a floating foundation, optionally any type of offshore foundation may be used as mentioned above. The forces and bending moment introduced into the offshore foundation 12 are smaller than those introduced into the offshore foundation 2 due to the reduced tower height and thus the reduced hub height. This means that the offshore foundation 12 in this embodiment has a size and/or weight that is/are smaller than those of the offshore foundation 2, since a smaller mass is needed to provide a stable platform. This in turn saves material and costs of the offshore foundation 12.

The clearance between the tip end of the wind turbine blades 3 and the sea level 10 is in this embodiment equal to or less than 25 metres, preferably between 5 and 20 metres.

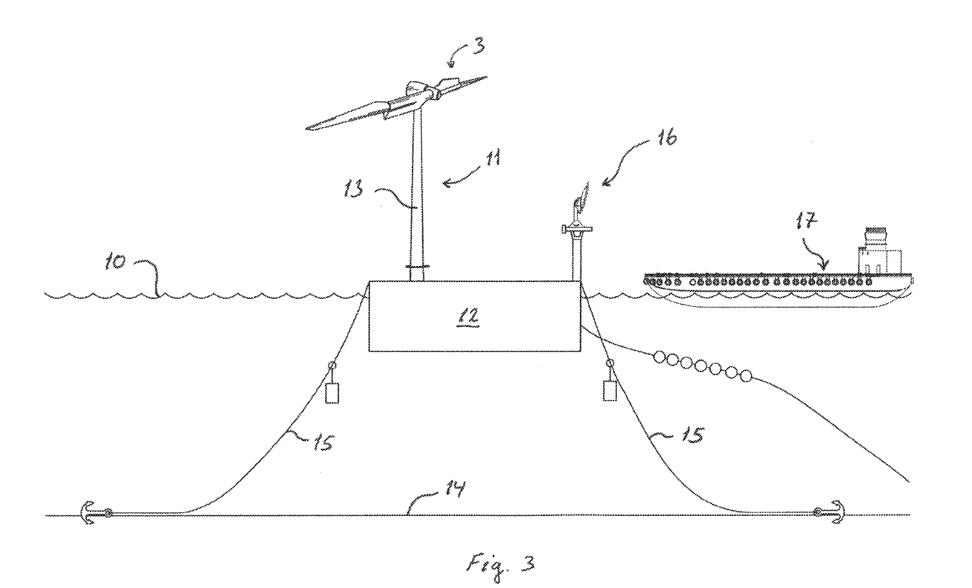

FIG. 3 shows the wind turbine 11 arranged on the offshore foundation 12 where the offshore foundation 12 is secured to a seabed 14 by means of one or more anchoring lines 15, e.g. anchor chains. One or more monitoring units 16 are arranged on the offshore foundation 12. The monitoring unit 16 is configured to detect any moving objects 17 within a monitoring area, such as vessels. The monitoring unit 16 comprises a radar configured to transmit an electromagnetic signal, e.g. radio waves, and receive the reflected signal from an object 17 located in the monitoring area. The monitoring unit 16 further comprises an electronic circuit, e.g. a microprocessor, configured to analyse the received signal and determine if the object 17 is located within the monitoring area or not, optionally also the direction and/or speed of the object 17. This defines a safety zone around the wind turbine structure 11, 12.

The monitoring unit 16 monitors the monitoring area and sends a signal or command to a control unit located in the wind turbine 11 indicating that an object 17 is located inside the monitoring area. The control unit then switches the wind turbine 11 to a shutdown mode in which the rotor is parked in a predetermined position. In the parked position, the rotor and thus the wind turbine blades 3 are rotated to a horizontal position as shown in FIG. 3 and optionally located in this position using a rotor locking system. This reduces the risk that the wind turbine blades 3 accidently hit the object 17. When the monitoring unit 16 determines that no objects 17 are located within the monitoring area, a second signal or command is send to the control unit. The control unit then switches the wind turbine 11 and the rotor into a normal operation mode or normal start-up mode depending on the measured wind speed.

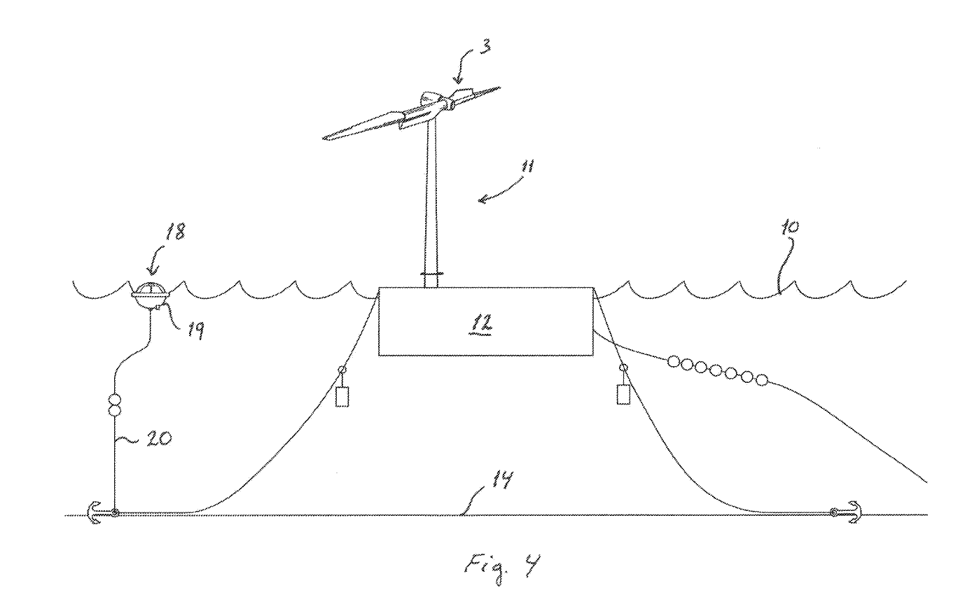

FIG. 4 shows a first exemplary embodiment of a measuring unit 18 arranged relative to the foundation 12. The measuring unit 18 is configured to measure the wave height relative to a nominal sea level, e.g. using a wave sensor, a GPS receiver or one or more accelerometers. The measuring unit 18 comprises a buoyant element 19, e.g. a buoy shaped element, configured to be placed at the sea level 10 so that it follows the wave movements. The buoyant element 19 is secured to the seabed 14 via one or more anchoring lines 20. Here only one measuring unit 18 is shown, but two or more measuring units 18 may be used.

The measuring unit 18 measures the wave height continuously or periodically and transmits the measured signals to the control unit in the wind turbine 11 via a wired or wireless connection. The control unit then determines the wave height and compares it to a predetermined threshold. Alternatively, the measuring unit 18 comprises an electronic circuit, e.g. a microprocessor, which determines the wave height and sends a signal indicating the wave height to the control unit. The threshold value may be 18 metres or less, preferably between 5 and 15 metres. If the measured wave height exceeds the threshold, then the control unit switches the wind turbine into the shutdown mode and the rotor is positioned in the parked position. When the measured wave height drops below the threshold, the control unit switches the wind turbine 11 and the rotor into the normal operation mode or normal start-up mode depending on the measured wind speed. This reduces the risk that the waves hit the wind turbine blades 3 during rotation.

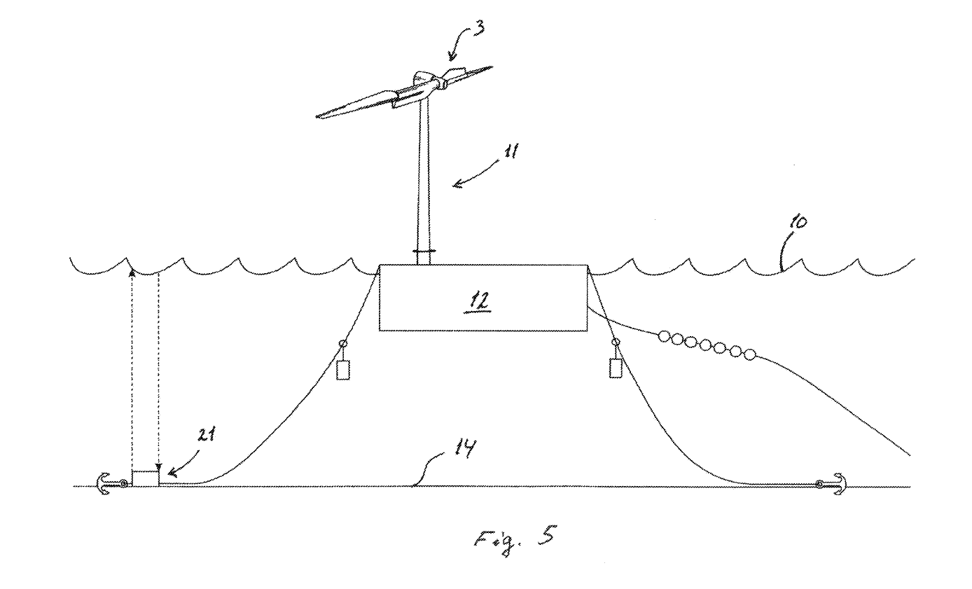

FIG. 5 shows a second exemplary embodiment of the measuring unit. The measuring unit 21 is in this embodiment arranged at the seabed 14 and connected to the control unit in the wind turbine 11 via a wired or wireless connection. The measuring unit 21 is configured to measure the wave height relative to the nominal sea level 10, e.g. using a sonar in the form of an upwards looking sonar.

The measuring unit 21 transmits an acoustic signal, e.g. acoustic pulses, towards the sea level 10 and receives a reflected signal from the sea level 10 as indicated by dotted lines in FIG. 5. The measuring unit 21, or the control unit, then determines the wave height. The measured wave height is then compared to the threshold as described above.

The present invention is not limited to the illustrated embodiment or the described embodiments herein, and may be modified or adapted without departing from the scope of the present invention as described in the patent claims below.

1. A method for optimising the weight of a wind turbine structure, the wind turbine structure comprises a wind turbine provided on an offshore foundation, the wind turbine comprises a rotor with at least two wind turbine blades and a rotor hub, the wind turbine further comprises a wind turbine tower, wherein the method comprises the steps of:
providing the wind turbine with a distance between a sea level and a lowermost position of a tip end of the at least two wind turbine blades which is equal to or less than 20 metres,
measuring at least a wave height,
operating the wind turbine according to the measured wave height,
positioning the rotor in a parked position with a maximum clearance between the at least two wind turbine blades and the sea level if at least the measured wave height exceeds a predetermined threshold.

2. The method according to claim 1, wherein the method further comprises determining a ratio between a blade length of one of the at least two wind turbine blades and a tower height of the wind turbine tower, wherein the ratio of the wind turbine is greater than 0.5.

3. The method according to claim 1, wherein the wind turbine is operated in a normal operation mode if the measured wave height is equal to or below the threshold.

4. The method according to claim 1, wherein the predetermined threshold is 18 metres or less, preferably between 8 metres and 18 metres.

5. The method according to claim 1, wherein the wind turbine is operated in a shutdown mode if the measured wave height is above the threshold.

6. The method according to claim 5, wherein the method further comprises monitoring a predetermined area relative to the offshore foundation, wherein the wind turbine is further operated in the shutdown mode if at least one moving object is detected within this area.

7. The method according to claim 1, wherein the step of positioning further comprises yawing the nacelle into a parked position in which the rotor is arranged on an opposite side of an outer ladder which provides access to the wind turbine.

8. A wind turbine structure comprising:
an offshore foundation configured to be installed at an installation site, the offshore foundation comprises an installation interface for a wind turbine,
the wind turbine comprises a wind turbine tower configured to be installed on the offshore foundation, a nacelle provided on top of the wind turbine tower, and a rotor rotatably mounted to the nacelle, the rotor comprises at least two wind turbine blades mounted to a rotor hub, the wind turbine further comprises a control unit configured to control the operation of the wind turbine, wherein
at least one measuring unit is configured to measure a wave height, the measuring unit being configured to communicate with the control unit, wherein
the wind turbine is further configured to position the rotor in a parked position with a maximum clearance between the at least two wind turbine blades and a sea level if the measured wave height exceeds a predetermined threshold, wherein the distance between the sea level and the lowermost position of a tip end of the at least two wind turbine blades is equal to or less than 20 metres.

9. The wind turbine structure according to claim 8, wherein the offshore foundation is a floating foundation.

10. The wind turbine structure according claim 8, wherein the distance between the sea level and the lowermost position is between 10 metres and 18 metres.

11. The wind turbine structure according to claim 8, wherein the at least one measuring unit is arranged on the wind turbine structure or positioned relative to the offshore foundation.

12. The wind turbine structure according to claim 8, wherein the wind turbine structure further comprises at least one monitoring unit configured to monitor a predetermined area relative to the offshore foundation, wherein the at least one monitoring unit is configured to detect at least one moving object within this area.

13. The wind turbine structure according to claim 12, wherein the wind turbine is configured to operate in a normal operation mode if no control signal is received from the at least one monitoring unit, wherein said control signal either indicative of the at least one moving object being located within this area or indicative of the at least one moving object is not approaching the wind turbine.

14. The wind turbine structure according to claim 8, wherein the wind turbine is configured to operate in a normal operation mode if the measured wave height is below the threshold.

15. The wind turbine structure according to claim 8, wherein the wind turbine comprises three wind turbine blades.
